(19) United States
(12) Patent Application Publication
(10) Pub. No.: US 2018/0104800 A1
(43) Pub. Date: Apr. 19, 2018

(54) Magnetic Tool Adapter

(71) Applicant: Cheng-Wei Su, Taichung City (TW)

(72) Inventor: Cheng-Wei Su, Taichung City (TW)

(21) Appl. No.: 15/296,080

(22) Filed: Oct. 18, 2016

(51) Int. Cl. B25B 23/00; B25B 23/12

(52) U.S. Cl. CPC B25B 23/0035; B25B 23/12

(57) ABSTRACT

A magnetic tool adapter includes a connecting structure and a flange structure. The connecting structure extends longitudinally along an axis and includes a driving end and a connecting end disposed at opposite ends and along the axis. The driving end is adapted to connect to a wrenching tool and the connecting end is adapted to connect to a drive socket respectively. The flange structure protrudes radially from the axis and outwardly from an outer periphery of the connecting structure and defines at least one slot. The at least one slot defines an opening at a first side of the flange structure. A magnetic member is insertably mounted in the at least one slot and is spaced from the opening.

### BACKGROUND OF THE INVENTION

### 1. Field of the Invention

The present invention relates to a tool adapter and, particularly, to a tool adapter of a magnetic type.

### 2. Description of the Related Art

U.S. Pat. No. 5,361,656 discloses an adapter for interfacing a wrench arm of a socket wrench with a plurality of sockets. The adapter includes a rim portion, two holes extending through the rim portion, and two small cylindrical magnets respectively disposed in the two holes. Although the adapter interfacing the wrench arm of the socket wrench and the socket includes the two magnets including first ends in a position capable of magnetically abutting an end surface of the wrench arm and second ends in a position capable of magnetically abutting an end surface of the socket respectively, the two magnets are exposed to impact by the socket and/or the socket wrench and are liable to crack.

The present invention is, therefore, intended to obviate or at least alleviate the problems encountered in the prior art.

### SUMMARY OF THE INVENTION

According to the present invention, a magnetic tool adapter includes a connecting structure and a flange structure. The connecting structure extends longitudinally along an axis and includes a driving end and a connecting end disposed at opposite ends and along the axis. The driving end is adapted to connect to a wrenching tool or an impact driving tool and the connecting end is adapted to connect to a drive socket respectively. The flange structure protrudes radially from the axis and outwardly from an outer periphery of the connecting structure and defines at least one slot. The at least one slot defines an opening at a first side of the flange structure. A magnetic member is insertably mounted in the at least one slot and is spaced from the opening.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide a magnetic tool adapter for interconnecting tools so that one tool can drive another tool.

It is another objective of the present invention that magnets of the magnetic tool adapter are prevented from impact from the tools magnetically connected thereto.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a magnetic tool adapter in accordance with a first embodiment of the present invention.

FIG. 2 is an exploded perspective view of FIG. 1.

FIG. 3 is a cross-sectional view of FIG. 1.

FIG. 4 is an exploded perspective view showing the magnetic tool adapter and tools connected thereto.

FIG. 5 is a perspective view of a magnetic tool adapter in accordance with a second embodiment of the present invention.

FIG. 6 is a cross-sectional view of FIG. 5.

### DETAILED DESCRIPTION OF THE INVENTION

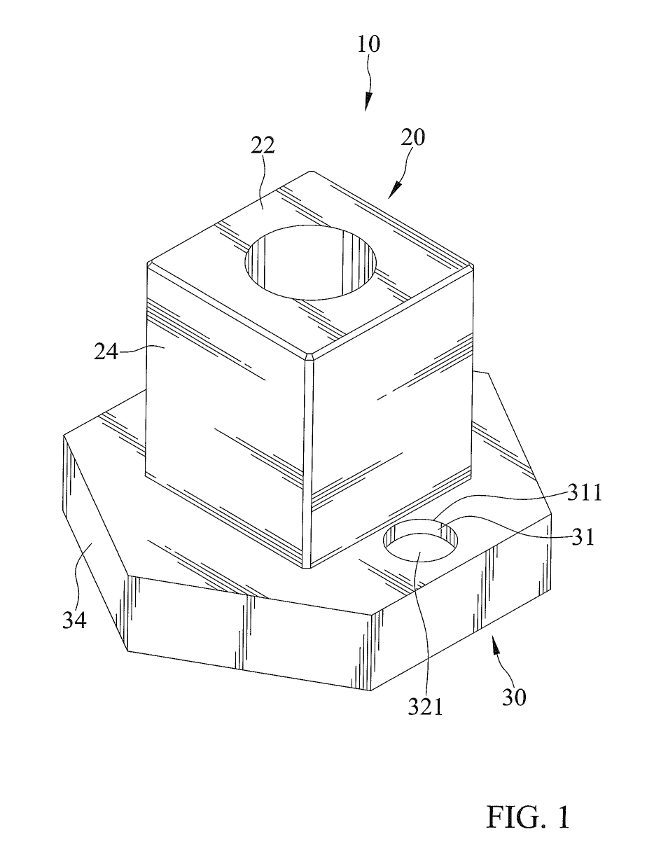

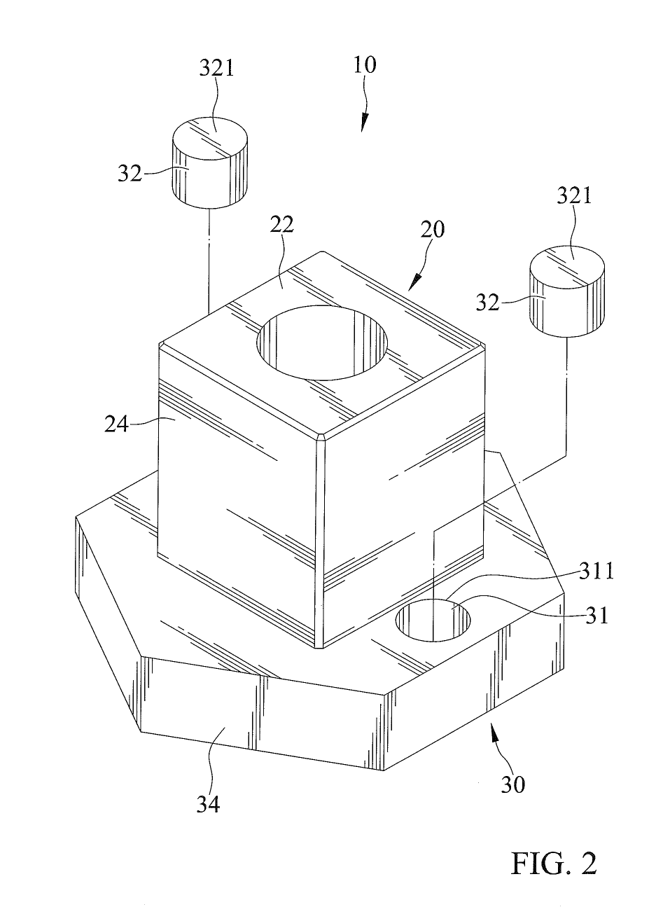

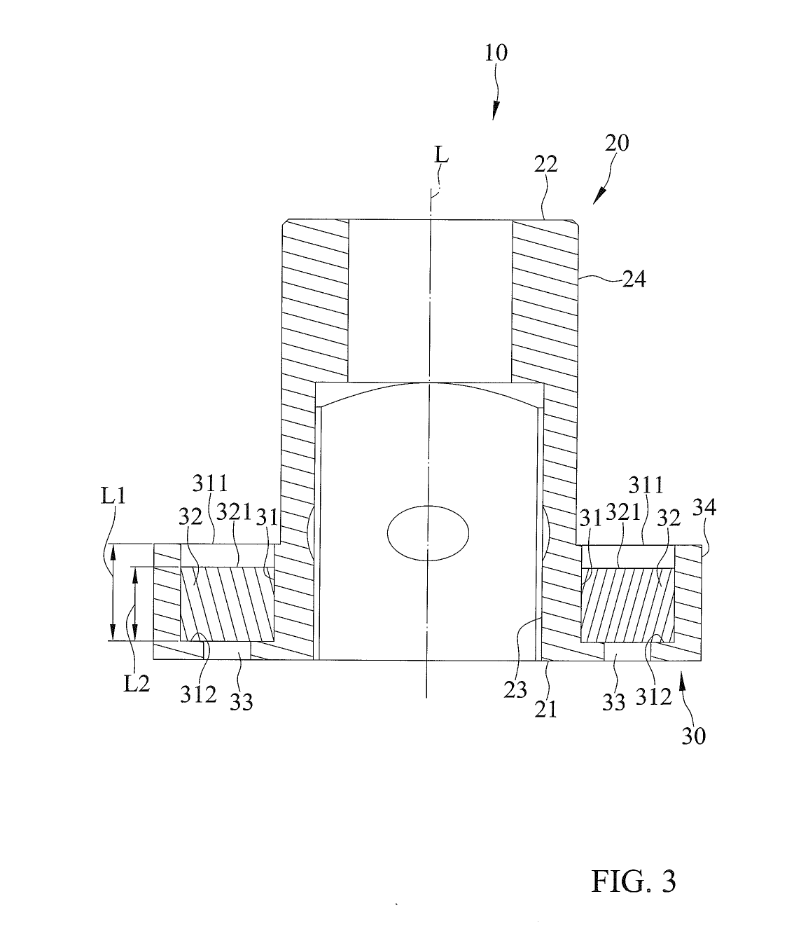

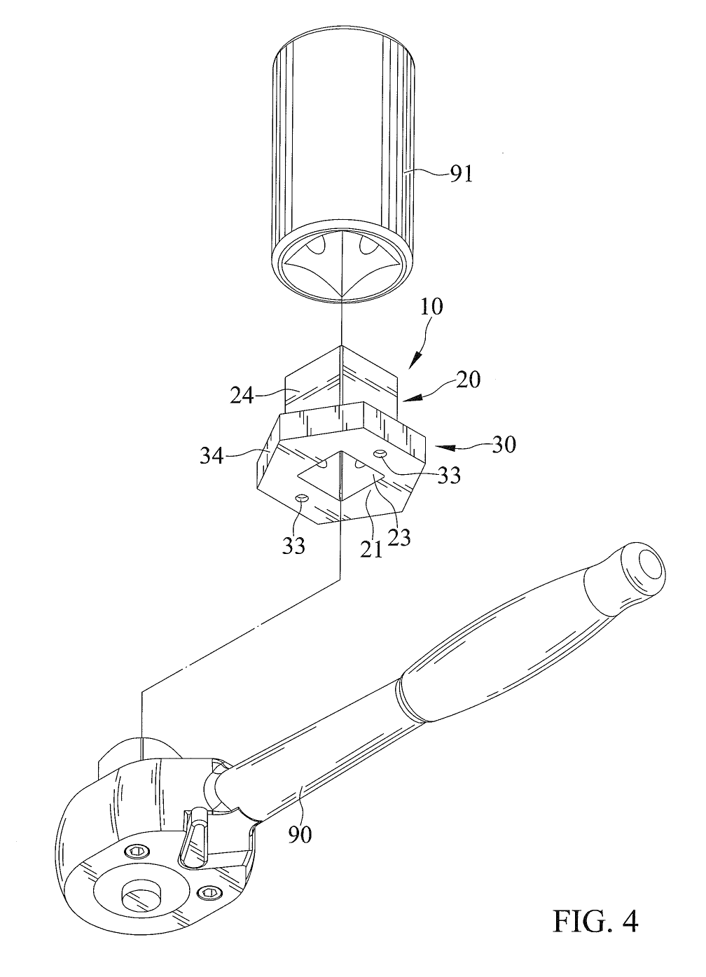

FIGS. 1 through 4 show a magnetic tool adapter 10 in accordance with a first embodiment of the present invention. The magnetic tool adapter 10 includes a connecting structure 20, a flange structure 30, and a magnetic member 32.

The connecting structure 20 extends longitudinally along an axis L and includes a driving end 21 and a connecting end 22 disposed at opposite ends and along the axis L.

The flange structure 30 protrudes radially from the axis L and outwardly from an outer periphery of the connecting structure 20 and defines at least one slot 31. The at least one slot 31 includes two slots 31. The two slots 31 are disposed on radially opposite sides of the axis L. The at least one slot 31 defines an opening 311 at a first side of the flange structure 30. The at least one slot 31 has a bottom side 312 opposing the opening 311. The bottom side 312 is spaced from the opening 311 a first distance defining a first height H1. The flange structure 30 has an outer periphery 34 radially spaced from the connecting structure 20 and the axis L. The flange structure 30 has a cross-sectional area greater than a cross-sectional area of the connecting end 22 of the connecting structure 20. The connecting end 22 of the connecting structure 20 protrudes above the flange structure 30. The outer periphery 34 of the flange structure 30 is polygonal in cross section, but not limited thereto. The outer periphery 34 of the flange structure 30 is hexagonal in cross section. A hole 33 extends to the at least one slot 31. The hole 33 defines a first open end at the bottom side 312 opening to the at least one slot 31 and a second open end at a second side of the flange structure 30 and opposing the opening 311 respectively. The first and second sides of the flange structure 30 are flat surfaces and are parallel to each other.

The magnetic member 32 is insertably mounted in the at least one slot 31 and is spaced from the opening 311. The magnetic member 32 is supported, from a bottom end, by the bottom side 312. The magnetic member 32 has a top magnetically attracting side 321, opposing the bottom end, spaced from the opening a second distance defining a second height H2. The second height H2 is smaller than the first height H1. The magnetic member 32 which, in cross section, has a first width and the hole 33 which, in cross section, has a second width, and wherein the first width is larger than the second width and the magnetic member 32 is unable to be inserted into the hole 33. Thus, when there is need to replace the magnetic member 32, an elongated member can insert through the hole 33 to push the magnetic member 32 out of the at least one slot 31.

The magnetic tool adapter 10 is adapted to be gripped from the flange structure 30.

A wrenching tool or an impact driving tool 90 can engage with and drive the connecting structure 20 from the drive end 21. The wrenching tool or the impact driving tool 90 is a tool adapted to drive an object rotationally about a rotational axis. In the embodiment, the wrenching tool or the impact driving tool 90 is a ratchet tool, but not limited thereto. The wrenching tool or the impact driving tool 90 can be an open-end wrench, or adjustable wrench, or tool that can rotate the magnetic tool adapter 10. The wrenching tool or the impact driving tool 90 includes an arm defining a gripping portion and an engaging structure located at an end of the arm and configured for engaging with the object to be driven. The engaging structure and the gripping portion are respectively at first and second ends of the wrenching tool or the impact driving tool 90. The driving end 21 is adapted to connect to the wrenching tool or the impact driving tool 90. The driving end 21 defines a cavity 23 and is configured for receiving the engaging structure of the wrenching tool or the impact driving tool 90. The connecting structure 20 includes an open end, the cavity 23 defines an opening, and the open end of the connecting structure is defined by the opening of the cavity 23. The cavity 23 extends longitudinally along the axis L. The cavity 23 is polygonal in cross section, but not limited thereto. The cavity 23 is quadrilateral in cross section. The wrenching tool or the impact driving tool 90 has a substantially flat end. Thus, the wrenching tool or the impact driving tool 90 and the second side of the flange structure 30 can flatly abut against each other substantially.

A drive socket 91 can connect to the connecting end 22 of the connecting structure 20. The connecting end 22 of the connecting structure 20 is in a form of a protrusion 24. The protrusion 24 extends longitudinally along the axis L. The protrusion 24 is polygonal in cross section, but not limited thereto. The protrusion 24 is quadrilateral in cross section. The drive socket 91 and the wrenching tool or the impact driving tool 90 are adapted to couple together and form a driving device including the drive socket 91 and the wrenching tool or the impact driving tool 90. ii The drive socket 91 is adapted to drive an object rotationally about a rotational axis. The drive socket 91 includes a driving end and a connecting end at opposite ends, with the driving end configured for engaging with the wrenching tool or the impact driving tool 90 and the connecting end configured for engaging with an object to be driven respectively. The driving end defines a receptacle. The connecting end defines a receptacle. The connecting end 22 is adapted to connect to a drive socket 91. The connecting end 22 is configured for engaging in the connecting end, i.e., the receptacle, of the drive socket 91. The drive socket 91 has a substantially flat end. Thus, the drive socket 91 and the first side of the flange structure 30 can flatly abut against each other substantially.

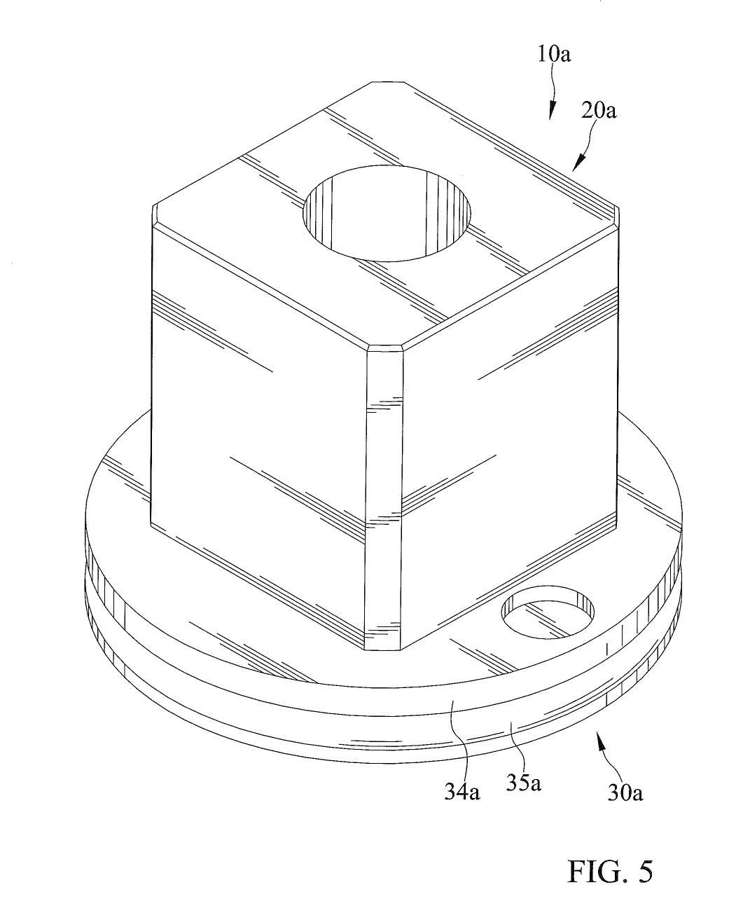

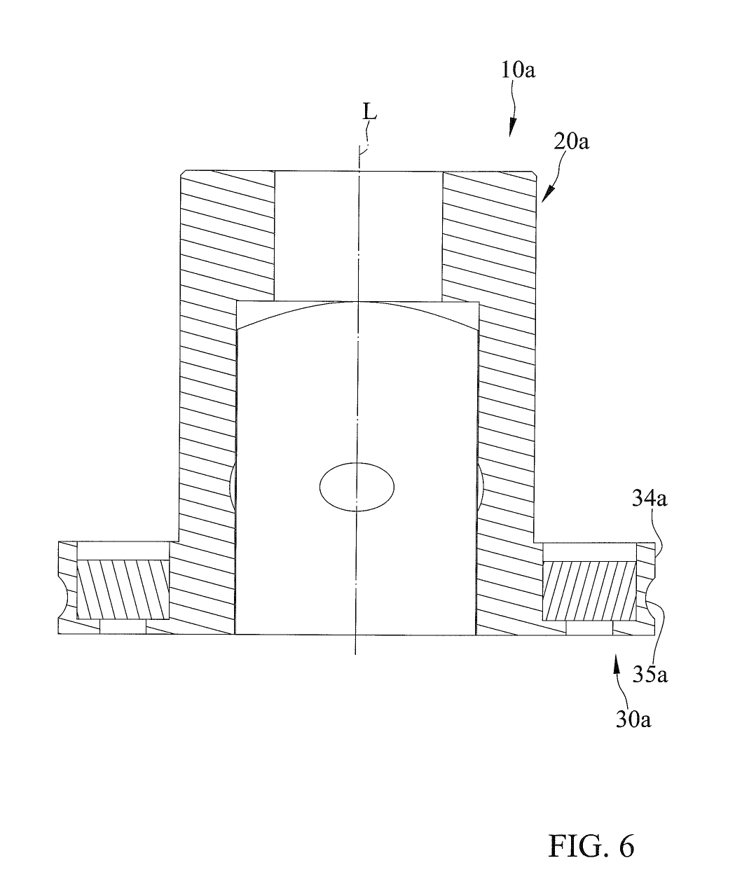

FIGS. 5 and 6 show a magnetic tool adapter 10a in accordance with a second embodiment of the present invention, and the same numbers are used to correlate similar components of the first embodiment, but bearing a letter a. Relationships of components set forth for the first embodiment also applies to the second embodiment. However, the second embodiment is different from the first embodiment in that a flange structure 30a, protruding radially from the axis L and outwardly from an outer periphery of the connecting structure 20a, has a contour different from a contour of the flange structure 30. In the embodiment, an outer periphery 34a of the flange structure 30a is circular in cross section. Further, a recess 35a extends radially from the axis L on the outer periphery 34a of the flange structure 30a and is configured to increase a user's grip around the flange structure 30a. The recess 35a also extends annularly around the circumference of the outer periphery 34a of the flange structure 30a. Thus, a knurling or other frictional means can form on the outer periphery 34a of the flange structure 30a to increase a user's grip on the flange structure 30a.

In view of the forgoing, the magnetic member 32 is prevented from impact from the wrenching tool or the impact driving tool 90 and/or the drive socket 91 magnetically connected thereto because the magnetic member 32 are spaced from the opening 311 of the at least one slot 31.

The foregoing is merely illustrative of the principles of this invention and various modifications can be made by those skilled in the art without departing from the scope and spirit of the invention.

What is claimed is:

1. A magnetic tool adapter comprising:
a connecting structure extending longitudinally along an axis and including a driving end and a connecting end disposed at opposite ends and along the axis, wherein the driving end is adapted to connect to a wrenching tool or an impact driving tool and the connecting end is adapted to connect to a drive socket respectively;
a flange structure protruding radially from the axis and outwardly from an outer periphery of the connecting structure and defining at least one slot, with the at least one slot defining an opening at a first side of the flange structure; and
a magnetic member insertably mounted in the at least one slot and is spaced from the opening.

2. The magnetic tool adapter as claimed in claim 1, wherein the at least one slot has a bottom side opposing the opening, wherein the magnetic member is supported, from a bottom end, by the bottom side, wherein the bottom side is spaced from the opening a first distance defining a first height, wherein the magnetic member has a top magnetically attracting side, opposing the bottom end, spaced from the opening a second distance defining a second height, and wherein the second height is smaller than the first height.

3. The magnetic tool adapter as claimed in claim 2 further comprising a hole extending to the at least one slot, wherein the hole defines a first open end at the bottom side opening to the at least one slot and a second open end at a second side of the flange structure and opposing the opening respectively, wherein the magnetic member which, in cross section, has a first width and the hole which, in cross section, has a second width, and wherein the first width is larger than the second width and the magnetic member is unable to be inserted into the hole.

4. The magnetic tool adapter as claimed in claim 3, wherein the flange structure has an outer periphery radially spaced from the connecting structure and the axis, wherein the flange structure has a cross-sectional area greater than a cross-sectional area of the connecting end of the connecting structure, and wherein the connecting end of the connecting structure protrudes above the flange structure.

5. The magnetic tool adapter as claimed in claim 4, wherein the outer periphery of the flange structure which, in cross section, is polygonal.

6. The magnetic tool adapter as claimed in claim 3, wherein the first and second sides of the flange structure are flat surfaces and are parallel to each other.

7. The magnetic tool adapter as claimed in claim 1, wherein the driving end of the connecting structure defines a cavity, wherein the cavity extends longitudinally along the axis, wherein the connecting structure includes an open end, wherein the cavity defines an opening, and wherein the open end of the connecting structure is defined by the opening of the cavity.

8. The magnetic tool adapter as claimed in claim 7, wherein the cavity which, in cross section, is polygonal.

9. The magnetic tool adapter as claimed in claim 7, wherein the connecting end of the connecting structure is in a form of a protrusion, and wherein the protrusion extends longitudinally along the axis.

10. The magnetic tool adapter as claimed in claim 9, wherein the cavity which, in cross section, is polygonal.

11. The magnetic tool adapter as claimed in claim 10, wherein the protrusion which, in cross section, is polygonal.

12. The magnetic tool adapter as claimed in claim 1, wherein the at least one slot includes two slots, and wherein the two slots are disposed on radially opposite sides of the axis.

13. The magnetic tool adapter as claimed in claim 4, wherein the outer periphery of the flange structure which, in cross section, is circular.

14. The magnetic tool adapter as claimed in claim 4, wherein the outer periphery of the flange structure includes a recess extending radially from the axis on the outer periphery of the flange structure.

15. The magnetic tool adapter as claimed in claim 14, wherein the recess extends annularly around the circumference of the outer periphery of the flange structure.
